(19) United States
(12) Patent Application Publication
(10) Pub. No.: US 2012/0100507 A1
(43) Pub. Date: Apr. 26, 2012

(54) METHOD OF FORMING A DENTAL MATRIX

(76) Inventor: Mark A. Olson, Price, UT (US)

(21) Appl. No.: 12/911,548

(22) Filed: Oct. 25, 2010

(51) Int. Cl. A61C 5/00

(52) U.S. Cl. 433/217.1

(57) ABSTRACT

A method of forming a dental matrix includes providing a strip of PTFE tape of a length sufficient to cover a portion of a patient's mouth during a dental procedure, drying the portion of the patient's mouth to which the strip of PTFE tape is to be applied, applying the strip of PTFE tape by stretching the PTFE tape over the portion of the patient's mouth to be protected from exposure to substances used in the at least one dental procedure thus causing the strip of PTFE tape to adhere to the patient's mouth over the portion to be protected, performing the dental procedure, and removing the strip of PTFE tape from the patient's mouth.

### FIELD OF THE INVENTION

The present invention relates generally to matrix materials used in dental procedures, and more specifically to a method of using a dental matrix material in the form of PTFE tape.

### STATE OF THE ART

Anterior teeth are those located in the front of the mouth, including the incisors and the cuspids. Normally, these are the teeth that are visible when a person smiles. The posterior teeth are those located in the back of the mouth-the bicuspids and molars.

In many dental procedures, it is necessary to protect adjacent teeth to work being performed on a particular tooth. For example, when repairing a front incisor that has been chipped, a common method known in the art is to repair such damage using a technique of direct composite resin restoration. This involves a process in which the damaged tooth is restored using composite resin materials to rebuild the tooth to approximate its pre-damaged state. Because the composite resin material is cured to a hardened form that approximates the hardness of porcelain, it is important to prevent the composite resin from being inadvertently deposited on adjacent teeth during the procedure. Accordingly, it is known in the art to provide dental matrix materials that are often in the form of metal or plastic rectangular strips that can be wedged between the teeth. The dental matrix strips are relatively rigid members that form a shield between the tooth being repaired and the adjacent teeth.

This process of using such dental matrix strips is employed when repairing cavities in anterior teeth in which fillings are required. Today, it is often the case that composite resin materials are used for filling material due to its relatively high strength and white color to match the natural color of the tooth being repaired. Due to their thickness, such matrix strips, however, can be difficult to insert in patients that have little space between teeth. Thus, it is often required to wedge the teeth apart using wooden wedges that are driven between the teeth in order to fit the dental matrix strips. Conversely, for patients that have relatively large gaps between teeth, it may be difficult to retain the dental matrix strips between the teeth as the dental matrix strips must be held between the teeth by compressive forces between the teeth. In addition, because the dental matrix is often in the form of a rigid rectangular strip of metal or plastic, the dental matrix itself can interfere with the dentist's ability to easily access the tooth being repaired and are often awkward to handle. In addition, when such matrix strips form a surface upon which the composite resin is formed, the hardened composite resin will have a flat side with abrupt edges that are difficult to remove. Thus, there is a need in the art to provide a dental matrix material that is easy to secure to the tooth or gums, that is easy to insert between teeth, will remain in place until removed by the dentist, does not interfere with the repair work being performed by the dentist and that is easy and inexpensive to manufacture.

Polytetrafluoroethylene (PTFE) is a synthetic fluoropolymer of tetrafluoroethylene. PTFE is most commonly known by its brand name, TEFLON. PTFE is known to have a very low coefficient of friction against solids and has found many applications, from cookware to thread seal tape. PTFE in tape form, commonly known as thread seal tape or plumber's tape is comprised of a PTFE film cut to specified widths for use in sealing pipe threads and is most commonly provided on a spool. In plumbing applications, PTFE tape is wrapped around the exposed threads of a pipe before it is screwed into place. Since the PTFE is malleable, deformable and impermeable, it behaves similar to a putty under compression. The PTFE is forced into any small gaps between threads and creates a watertight seal. One of the touted characteristics of PTFE is its ability to defeat friction.

There are two US standards for determining the quality of PTFE tape. MIL-T-27730A requires a minimum thickness of 3.5 mils and a minimum PTFE purity of 99%. A-A-58092 is a commercial standard which maintains the thickness requirement of MIL-T-27730A and adds a minimum density of 1.2 g/cc. PTFE tape is most commonly a white film (the natural color of PTFE), but it is also available in various colors. While pigmented thread seal tape is not materially different from the natural white tape, it is often used to correspond to color coded pipelines.

Dental floss is most commonly comprised of waxed string. The wax provides a low friction surface for the string so that the string can slide between teeth during flossing. More recently, PTFE has been employed. Because of PTFE's low friction characteristics, small strands of PTFE have been used for dental floss. The low friction characteristics allow the PTFE to easily slide between teeth when flossing. While PTFE in tape form has been known to have particular applicability for sealing purposes when connecting together threaded couplings in plumbing applications and small thread-like strands of PTFE have been employed as dental floss, the present invention is directed to new and useful methods of using PTFE tape as a dental matrix during various dental procedures. These and other advantages are provided by a method of forming a dental matrix from PTFE tape according to the present invention set forth hereinafter.

### SUMMARY OF THE INVENTION

Accordingly, the present invention includes a method of forming a dental matrix, which includes the steps of providing a strip of PTFE tape of a length sufficient to wrap at least once around a first tooth, drying the first tooth with air to create a dry tooth surface around the entire first tooth, applying the strip of PTFE tape by stretching and wrapping the PTFE tape around the first tooth and within the interdental space between the first tooth and a second tooth that is an anterior tooth adjacent to the first tooth on which at least one dental procedure is to be performed so as to conform the strip of PTFE tape to the contour of the first tooth, performing the at least one dental procedure on the second tooth and removing the strip of PTFE tape from the first tooth. The dental procedure on the second tooth may include repairing the second tooth with a filling, repairing a chipped or broken part of the second tooth or applying a veneer to the second tooth.

In an alternative embodiment, the method further comprises drying a third tooth with air to create a dry tooth surface around the entire third tooth, the third tooth being adjacent to the second tooth and on the opposite side from the first tooth. A second strip of PTFE tape is applied by stretching and wrapping the second strip of PTFE tape around the third tooth so as to be within an interdental space between the second tooth and the third tooth.

In another embodiment, the strip of PTFE tape is applied around the first tooth by wrapping the strip of PTFE tape at least one complete time around the first tooth.

In yet another embodiment, the method includes applying the strip of PTFE tape around the first tooth and a portion of the adjacent gum.

In still another embodiment, the dental procedure comprises performing a tooth restoration procedure of the second tooth by applying a composite resin to the second tooth.

In another embodiment, the dental procedure comprises applying a veneer to the second tooth by applying an adhesive to the second tooth.

In still another embodiment, a method of forming a dental matrix includes providing a strip of PTFE tape of a length sufficient to cover a portion of a patient's mouth during a dental procedure. To do so, the portion of the patient's mouth to which the strip of PTFE tape is to be applied is dried and the strip of PTFE tape is applied by stretching the PTFE tape over the portion of the patient's mouth to be protected from exposure to substances used in the dental procedure, causing the strip of PTFE tape to adhere to the patient's mouth over the portion to be protected.

In yet another embodiment, the dental procedure includes making a dental impression.

### BRIEF DESCRIPTION OF THE DRAWINGS

The following drawings illustrate exemplary embodiments for carrying out the invention. Like reference numerals refer to like parts in different views or embodiments of the present invention in the drawings.

FIG. 1 is a partial front view of a set of upper anterior teeth with a fractured tooth.

FIGS. 2-12 are partial front views of the set of upper anterior teeth illustrating a prior art method of restoring the fractured tooth.

FIGS. 13A, 14A, 15A, 16A and 17 are partial front views of the upper anterior teeth illustrating a method of forming a dental matrix in accordance with the principles of the present invention.

FIGS. 13B, 14B, 15B and 16B are partial bottom views of the upper anterior teeth illustration the method of forming a dental matrix in accordance with the principles of the present invention.

FIGS. 18-28 are partial front views of the set of upper anterior teeth illustrating a method of restoring the fractured tooth according to the principles of the present invention.

FIG. 29 is a partial bottom view of a set of upper anterior teeth with an open socket.

FIG. 30 is a partial bottom view of the set of upper anterior teeth with a strip of PTFE tape covering the open socket and surrounding gums according to the principles of the present invention.

FIG. 31 is a partial front view of the set of upper anterior teeth with the strip of PTFE tape covering the open socket and surrounding gums according to the principles of the present invention.

### DETAILED DESCRIPTION OF THE ILLUSTRATED EMBODIMENTS

Those of ordinary skill in the art will realize that the following description of the present invention is illustrative only and not in any way limiting. Other embodiments of the invention will readily suggest themselves to such skilled persons.

The development of direct composite resin restoration as a viable treatment option for aesthetic restoration of anterior teeth, especially in the case of uncomplicated tooth fractures as well as cavity repairs, has been a major leap forward in general dentistry techniques. Recent developments in adhesive technology and composite material properties have further advanced such dental procedures. Due to the nature of techniques and materials used in such procedures, it is often important to protect adjacent teeth from exposure to adhesives and composite resin materials. The present invention provides a method of utilizing a dental matrix material formed from PTFE tape during various dental procedures, including but not limited to restoration or repair of an anterior tooth, attachment of porcelain veneer application to anterior teeth, formation of dental impressions, etc.

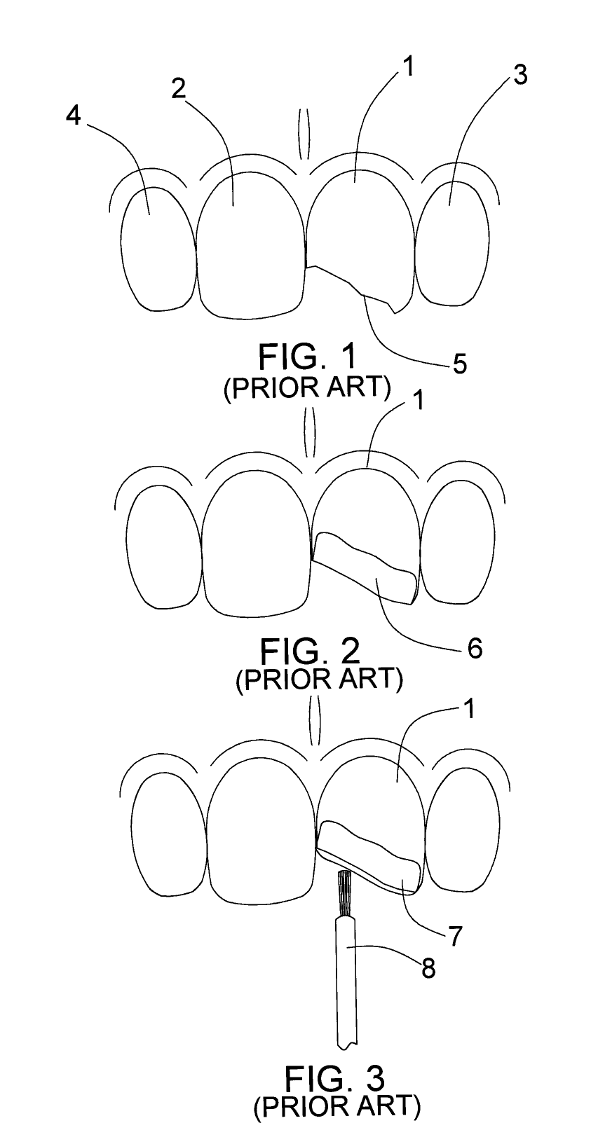

FIGS. 1 to 12 illustrate a prior art method for restoring a front incisor tooth 1, specifically, an upper central front incisor that has been chipped. In this example, the pulp has not been damaged that would require other treatment options. Restoration is achieved by application of a composite resin to build up the damaged portion of the tooth 1. FIG. 1 shows a partial front view of four upper anterior teeth 1-4, with tooth 1 having been fractured resulting in a fractured edge 5. As shown in FIG. 2, a small bevel 6 (e.g., 1 mm in height) is formed on the front surface of the tooth along the edge 5 and extends about the length of the edge 5 of the chipped tooth 1. On the back surface (not shown) of the tooth 1, a rounded margin is formed

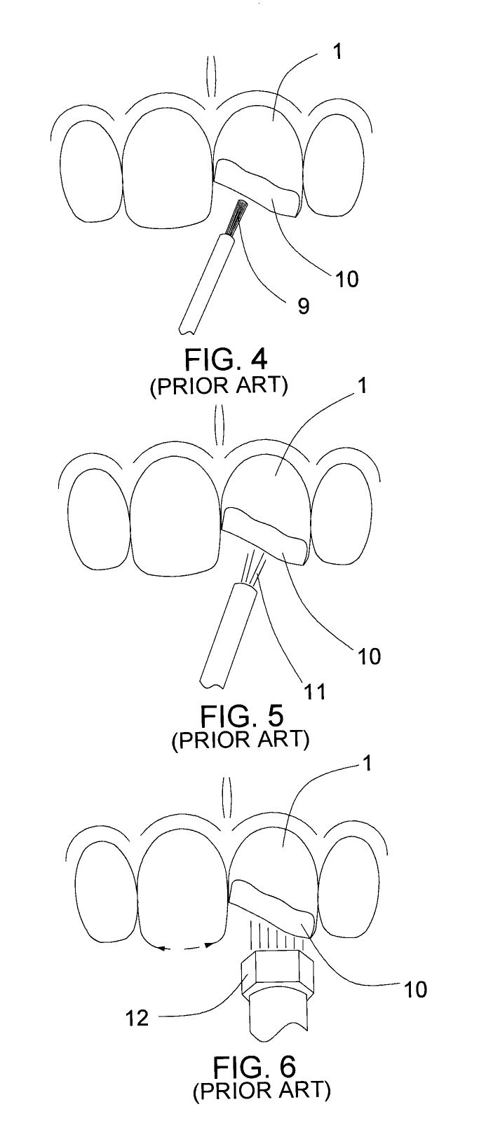

As shown in FIG. 3, an etching material 7, such as a phosphoric acid preparation, is applied to the tooth 1 with a brush 8 along the bevel 6 and the rounded margin on the palatal surface of the tooth 1. This etching material 7 is applied for a short period of time (e.g., ten to twenty seconds) and then rinsed away with water and air dried. Next, as shown in FIG. 4, an adhesive 9 is brush applied to the prepared portion 10 of the tooth 1, air thinned with a jet of air as shown in FIG. 5, and then polymerized with an ultraviolet light 12 as shown in FIG. 6

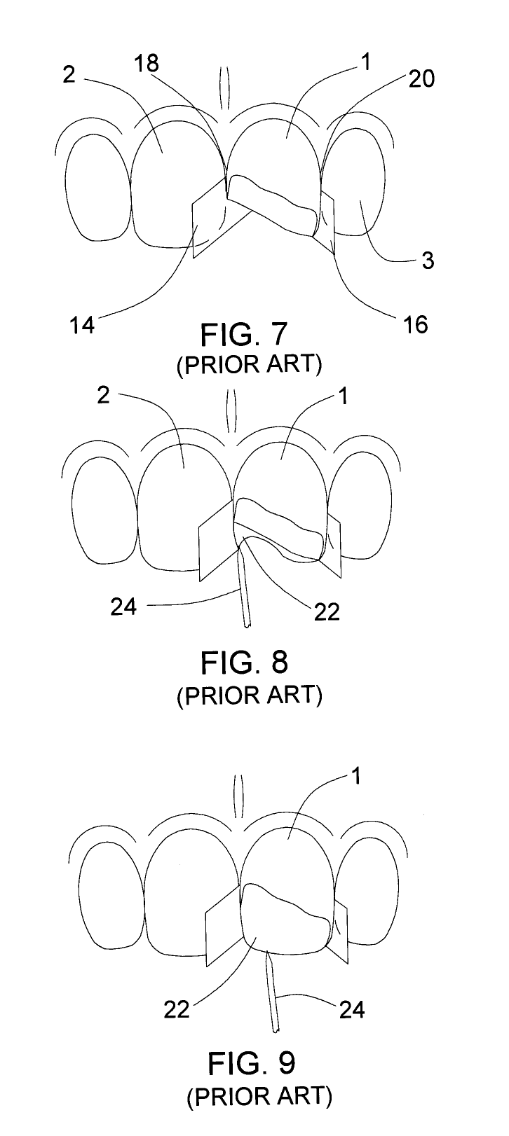

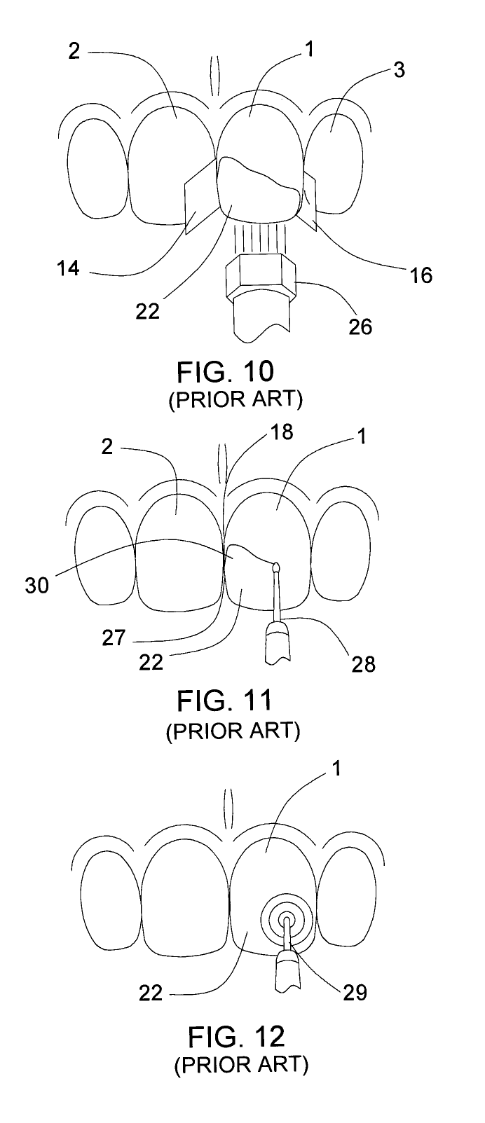

Once the tooth 1 has been properly prepared for deposition of the composite resin, matrix strips 14 and 16 are wedged interdentally within the interstices 18 and 20, respectively, between teeth 1, 2 and 3. The prior art matrix strips 14 and 16 are formed from strips of semi-rigid metal or plastic sheets that effectively form small walls between the teeth 1, 2 and 3. This prevents the composite resin 22 from being inadvertently applied to the adjacent teeth 2 and 3 to tooth 1 as shown in FIG. 8. As shown in FIG. 9, the composite resin 22, which may be in the form of an ultraviolet light curable nano-composite resin, is gradually built up and sculpted using a long bladed dental tool 24. During the procedure and between each deposited layer of the composite resin 22, the composite resin is cured using an ultraviolet light source 26 as shown in FIG. 10.

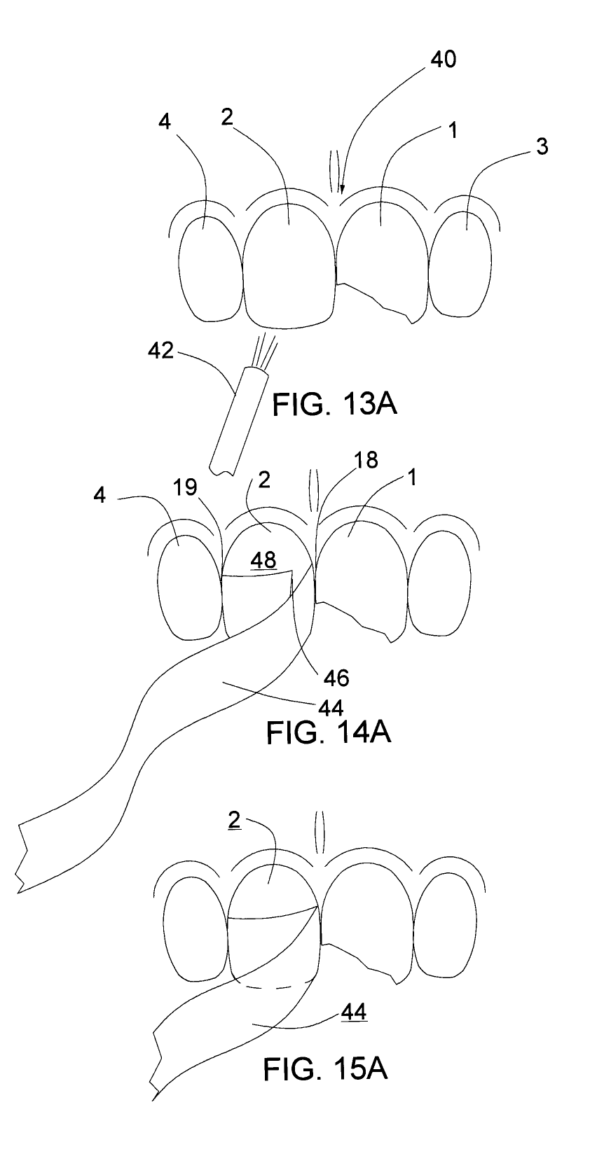

The dental matrix strips 14 and 16 are removed so that the cured composite resin 22, which is now permanently attached to tooth 1, can be finished with dental tool 28 to contour, adjust, shape, texture and smooth the restoration as shown in FIG. 11. Because the dental matrix strips 14 and 16, however, are in the form of relatively flat members extending interdentally between the teeth 1, 2 and 3, the cured composite resin material 22 adjacent to the matrix strip 14, for example, will have an edge contour 27 that matches the shape of the matrix strip 14. In other words, because the matrix strip will create a form against which an edge of the resin 22 will abut, the restored portion 30 of the tooth 1 will be left with abrupt edges along the edge contour 27 that must be removed to give the tooth 1 a more natural shape when finished. This requires significant work in the interdental gap 18 between the tooth 1 and tooth 2, for example. During such finishing work, extreme care must be taken not to cause damage to the adjacent tooth 2. As shown in FIG. 12, the restoration is polished with dental tool 29 to produce surface luster and a highly reflective surface, thus restoring the tooth 1 to its pre-damaged state.

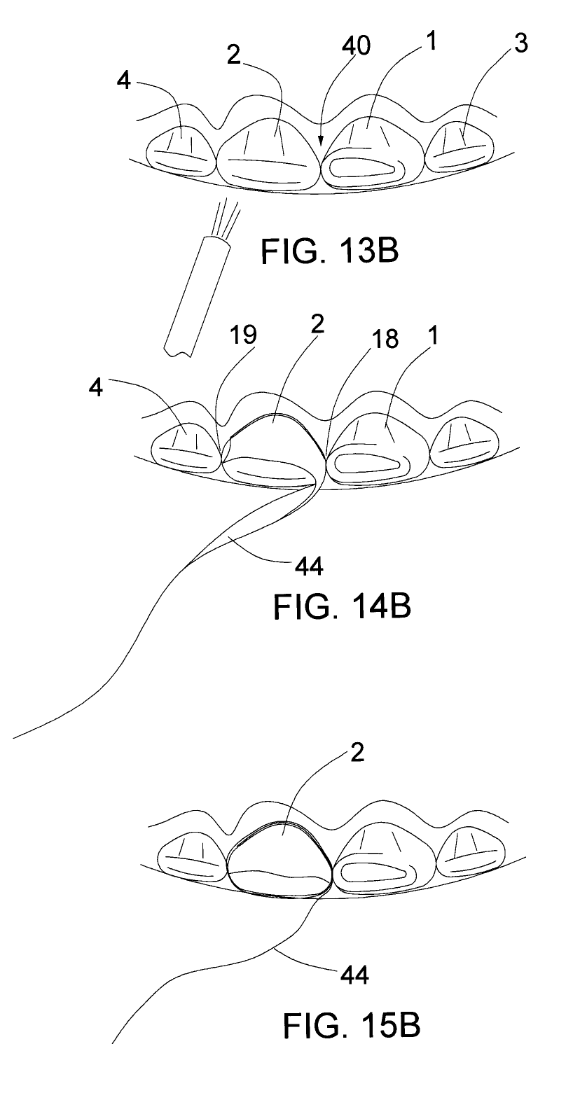

Referring now to FIGS. 13A-17, there is illustrated a method of forming a dental matrix in accordance with the principles of the present invention. In order to illustrate the techniques of the present invention, the procedure for repair of the broken tooth 1 illustrated in FIGS. 1-12 is followed with the exception of the type and application of dental matrix materials used. As shown in FIGS. 13A and 13B, in order for the dental matrix material of the present invention to be successfully employed, the teeth 2 and 3, gums 40 and adjacent teeth 4 must be thoroughly dried using an air nozzle 42 to remove any saliva or water from the surrounding tooth and gum surfaces. This allows the dental matrix material of the present invention to “adhere” to the surface of the tooth to which the material is to be applied and to itself. As shown in FIGS. 14A and 14B, a strip 44 of PTFE tape is prepared as by cutting from a spool of such PTFE tape. The strip 44 of PTFE tape is of sufficient length to be wrapped at least one time around the tooth 2. To apply, the strip 44 is slid between the interdental spaces 18 and 19 between the teeth 1, 2 and 4. The leading or proximal edge 46 of the strip 44 is positioned on the front of the tooth with the strip of PTFE tape lying flat against the surface 48 of the tooth 2. As shown in FIGS. 15A and 15B, the strip 44 is subsequently wrapped around the tooth 2 so that the strip 44 of PTFE tape overlays upon itself. To cause the strip 44 to “bond” to itself, the strip 44 is tautly stretched as it is wrapped around the tooth 2. This also causes the strip 44 to conform to the shape of the tooth 2 so as to form a thinly wrapped matrix around the tooth 2. Because the PTFE tape has a thickness of only about 3 mils, the tape can be wrapped more than one time around the tooth 2 without becoming too thick and can relatively easily be inserted between the teeth 1, 2 and 4 with each successive wrap. Often, it is only necessary to provide just over one continuous wrap around the tooth 2 for the PTFE tape matrix to maintain its position on the tooth 2 during a dental operation. That is, because the PTFE tape is stretchable, deformable, conformable, moldable and has self adhesive properties it will adhere to the tooth 2 and surrounding gum line tissue due to sufficient bonding between the tooth 2 and the PTFE tape 44 and the PTFE tape 44 upon itself to hold the PTFE tape 44 in place.

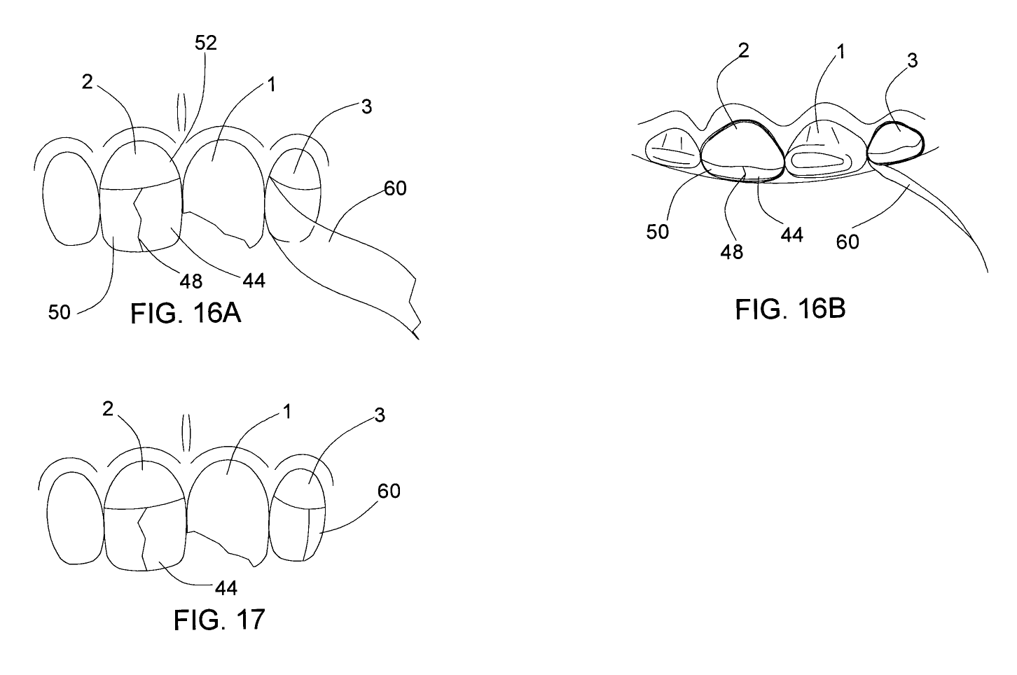

Once the tooth 2 has been adequately wrapped with the PTFE tape, as shown in FIGS. 16A and 16B, the unused portion of the PTFE tape 44 can be removed as by tearing or cutting the tape 44. The resulting trailing or distal end 48 of the tape 44 can then be pressed against the underlying wrap 50 of the PTFE tape. Because the PTFE tape is stretchable and moldable, the PTFE tape 44 can be stretched and molded so as to exactly match the contour of the underlying tooth 2, Thus, the PTFE tape 44 can be formed to cover the entire exposed surface of the tooth 2 below the gum line 52 if desired or necessary. As further illustrated in FIGS. 16A and 16B, the tooth 3 that is adjacent to tooth 1 can be wrapped with a strip 60 of PTFE tape in a manner similar to the technique illustrated and described with reference to strip 44. As shown in FIG. 17, when completed, the exposed surfaces of the teeth 2 and 3 that are to be protected during a repair operation of tooth 1 are protected by the PTFE tape matrix strips 44 and 60 respectively. Thus, various procedures employed during repair of the tooth 1 can be performed without interference by the dental matrix strips 44 and 60.

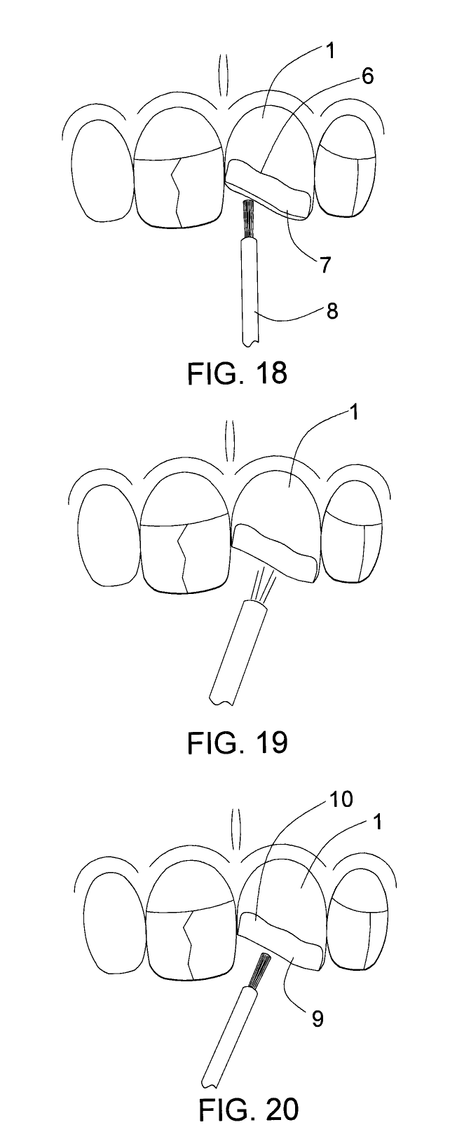

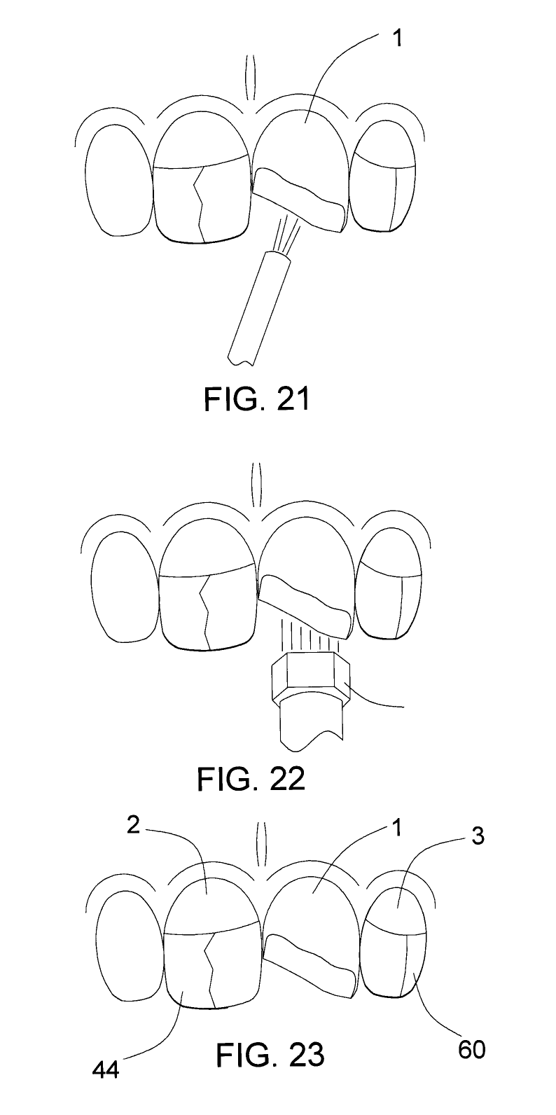

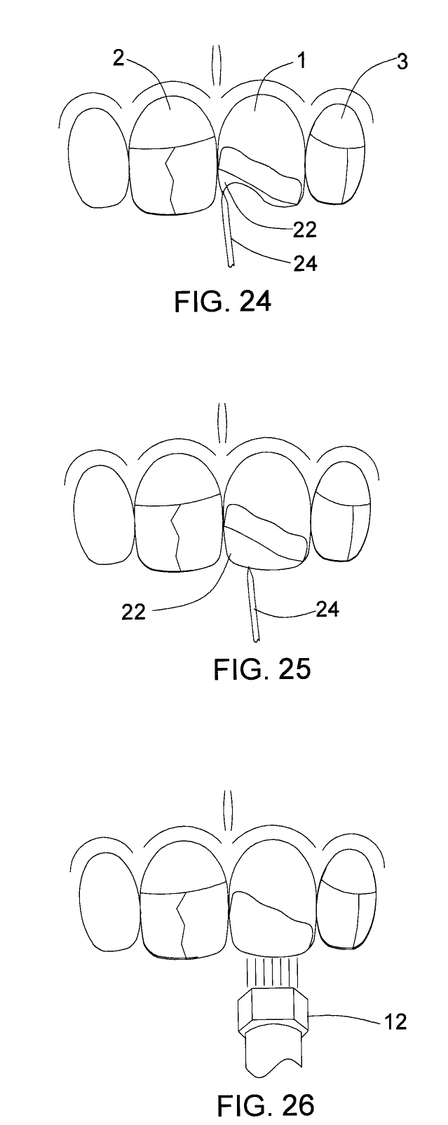

As shown in FIG. 18, the etching material 7, such as a phosphoric acid preparation, is applied to the tooth 1 with a brush 8 along the bevel 6 and the rounded margin on the palatal surface of the tooth 1. This etching material 7 is applied for a short period of time (e.g., ten to twenty seconds) and then rinsed away with water and air dried as shown in FIG. 19. Next, as shown in FIG. 20, an adhesive 9 is brush applied to the prepared portion 10 of the tooth 1, air thinned with a jet of air as shown in FIG. 5, and then polymerized with an ultraviolet light 12 as shown in FIG. 22. In this case, the various previous steps can all be performed with the matrix strips 44 and 60 already applied to the teeth 2 and 3. Alternatively, the matrix strips 44 and 60 can be applied after the tooth 1 has been prepared for application of the composite resin. This prevents the composite resin 22 from being inadvertently applied to the adjacent teeth 2 and 3 to tooth 1 as shown in FIG. 24. As shown in FIG. 25, the composite resin 22, which may be in the form of an ultraviolet light curable nano-composite resin, is gradually built up and sculpted using a long bladed dental tool 24. During the procedure and between each deposited layer of the composite resin 22, the composite resin is cured using the ultraviolet light source 12 as shown in FIG. 26.

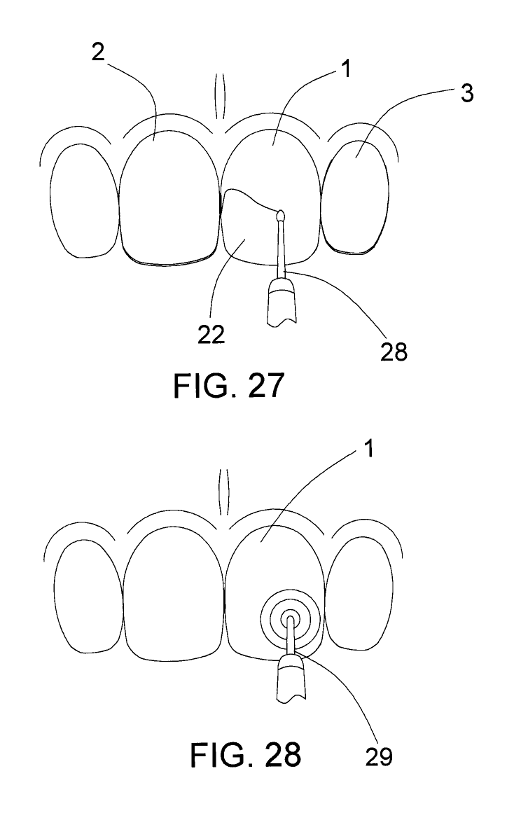

The dental matrix PTFE strips 44 and 60 are removed so that the cured composite resin 22, which is now permanently attached to tooth 1, can be finished with dental tool 28 to contour, adjust, shape, texture and smooth the restoration as shown in FIG. 27. Because the dental matrix PTFE strips 44 and 60 were in the form of the contour of the adjacent teeth 2 and 3, the formation of the composite resin 22 was not inhibited or otherwise limited by the dental matrix. As such, when the composite resin 22 is applied to the tooth 1, the general shape of the tooth 1 can be maintained, even at the interdental gaps between the teeth 1 and 2 and 1 and 3. Thus, there is less work required to finish the tooth as shown in FIG. 26 as less composite resin material needs to be removed during the finishing operation. In addition because less finishing work is required in the interdental gaps, it is less likely that any damage to adjacent teeth 2 and 3 will occur during finishing. As shown in FIG. 28, the restoration is polished with dental tool 29 to produce surface luster and a highly reflective surface, thus restoring the tooth 1 to its pre-damaged state.

The foregoing procedures for the formation and application of PTFE dental matrix strips according to the principles of the present invention may be applied when repair work or veneer application is performed on any of the anterior teeth of a patient, including both upper and lower teeth. For the posterior teeth, which includes the molars, dental matrix devices, most often in the form of metal rings that can be tightened around the tooth being repaired, are utilized. Such metal ring matrix devices, however, are not readily applicable for use on the anterior teeth resulting in a need in the art for the PTFE matrix strips and the method of using such PTFE matrix strips according to the principles of the present invention.

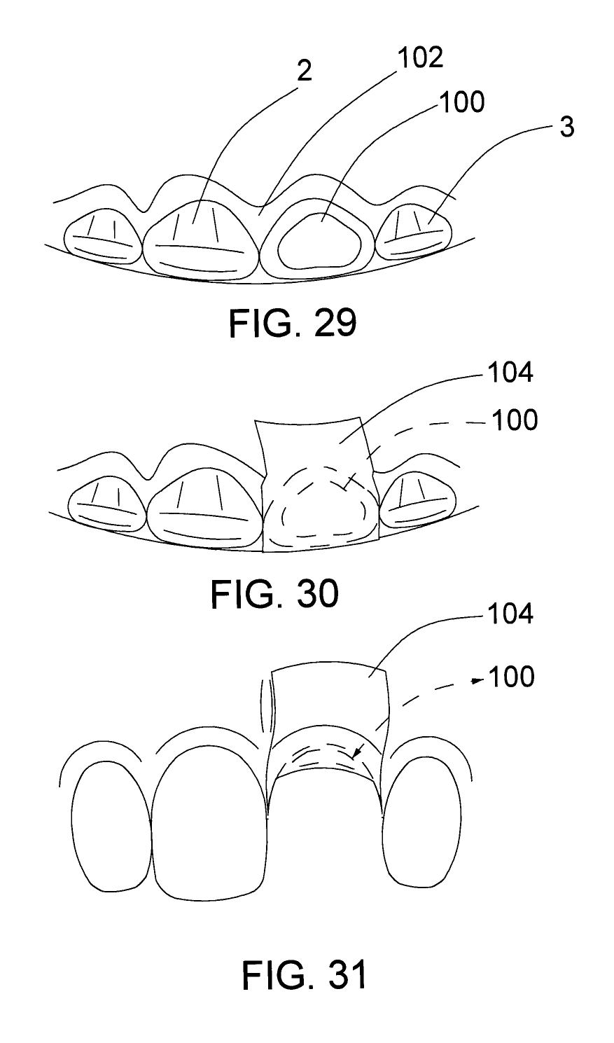

It is further contemplated according to the present invention that the PTFE matrix strips also have application in other dental procedures. For example, as shown in FIGS. 29-31, an open socket 100 in the upper gum 102 between adjacent teeth 2 and 3 is illustrated. Often times, it is necessary to make a dental impression when such open sockets 100 are present. It is not desirable, however, for the material used to form the impression (often in the form of a self setting impression material that hardens to a certain extent over time). In order to prevent the impression material from entering and being formed with a projection corresponding to the open socket 100, a strip 104 of PTFE tape is stretched over the open socket 100 and attached to the gum 102. This is possible by first drying, as previously described, the gum 102 and surrounding areas to provide a dry surface to which the PTFE tape can be adequately adhered. Stretching the PTFE tape over the open socket 100 causes the PTFE tape to mold to the exact contour of the portion of the gum 102 over which the PTFE tape is applied while providing an adequately strong cover over the open socket 100. In essence, a thin membrane is formed over the socket 100 to prevent the impression material from entering the open socket 100 during the impression making process. The result is that the finished impression properly molds to the shape of the gum 102 around and over the open socket 100 without inclusion of the open socket itself.

It would be apparent to those skilled in the art upon understanding the teachings of the present invention that there may be other uses of PTFE tape in dental procedures without departing from the inventive concepts herein. It should be noted that reference herein, including the claims, to PTFE refers generally to polytetrafluoroethylene containing materials that may be a synthetic fluoropolymer of tetrafluoroethylene. It is further noted that use of the term PTFE is not limited to materials containing PTFE of a particular quality or quantity. Thus, the purity of the PTFE is not intended to be an inherent or express limitation of that term as used in the claims. Generally, reference to “PTFE” or “PTFE tape” refers to a material that has a low coefficient of friction against solids and behaves in a manner similar to PTFE.

Thus, while there have been described various embodiments of the present invention, those skilled in the art will recognize that other and further changes and modifications may be made thereto without department from the spirit of the invention, and it is intended to claim all such changes and modifications that fall within the true scope of the invention. It is also understood that, as used herein and in the appended claims, the singular forms “a,” “an,” and “the” include plural reference, unless the context clearly dictates otherwise.

Unless defined otherwise, all technical and scientific terms used herein have the same meanings as commonly understood by one of ordinary skill in the art to which this invention belongs. While various methods and structures of the present invention are described herein, any methods or structures similar or equivalent to those described herein may be used in the practice or testing of the present invention. All references cited herein are incorporated by reference in their entirety and for all purposes. In addition, while the foregoing advantages of the present invention are manifested in the illustrated embodiments of the invention, a variety of changes can be made to the configuration, design and construction of the invention to achieve those advantages including combinations of components of the various embodiments. Hence, reference herein to specific details of the structure and function of the present invention is by way of example only and not by way of limitation.

1. A method of using PTFE tape as a dental matrix, comprising;
providing a strip of PTFE tape of a length sufficient to wrap at least once around a first tooth;
drying the first tooth with air to create a sufficiently dry tooth surface around the entire first tooth;
applying the strip of PTFE tape by stretching and wrapping the strip of PTFE tape around the first tooth and within the interdental space between the first tooth and a second tooth that is an anterior tooth adjacent to the first tooth on which at least one dental procedure is to be performed so as to conform the strip of PTFE tape to the contour of the first tooth and to cause the strip of PTFE tape to conform to the shape of the first tooth and to self-adhere to and maintain position relative to the first tooth without any adhesive or any additional element;
performing the at least one dental procedure on the second tooth; and
removing the strip of PTFE tape from the first tooth.

2. The method of claim 1, wherein the at least one dental procedure on the second tooth is selected from the group comprising repairing the second tooth with a filling, repairing a chipped or broken part of the second tooth and applying a veneer to the second tooth.

3. The method of claim 1, further comprising drying a third tooth with air to create a dry tooth surface around the entire third tooth, the third tooth being adjacent to the second tooth and on the opposite side from the first tooth and applying a second strip of PTFE tape by stretching and wrapping the second strip of PTFE tape around the third tooth so as to be within an interdental space between the second tooth and the third tooth and to cause the second strip of PTFE tape to conform to the shape of the third tooth and to self-adhere to and maintain position relative to the third tooth without any adhesive or any additional element.

4. The method of claim 1, wherein the applying the strip of PTFE tape around the first tooth comprises wrapping the strip of PTFE tape at least one complete time around the first tooth to cause the strip of PTFE tape to self-adhere to itself without any adhesive.

5. The method of claim 1, wherein the applying the strip of PTFE tape around the first tooth comprises wrapping the strip of PTFE tape around the first tooth and a portion of the adjacent gum and to cause the PTFE tape to conform and to self-adhere to and maintain position relative to the adjacent gum without any adhesive or other element.

6. The method of claim 2, wherein the performing at least one dental procedure comprises performing a tooth restoration procedure of the second tooth by applying a composite resin to the second tooth and wherein the strip of PTFE tape protects the first tooth from exposure to the composite resin.

7. The method of claim 2, wherein the performing at least one dental procedure comprises applying a veneer to the second tooth by applying an adhesive to the second tooth and wherein the strip of PTFE tape protects the first tooth from exposure to the adhesive.

8. A method of using PTFE tape as a dental matrix, comprising;
providing a strip of PTFE tape of a length sufficient to cover a portion of a patient's mouth during at least one dental procedure;
drying the portion of the patient's mouth to which the strip of PTFE tape is to be applied;
applying the strip of PTFE tape by stretching the strip of PTFE tape over the portion of the patient's mouth to be protected from exposure to substances used in the at least one dental procedure thus causing the strip of PTFE tape to self-adhere without any adhesive and to maintain position without any additional element to the patient's mouth over the portion to be protected;
performing the at least one dental procedure; and
removing the strip of PTFE tape from the patient's mouth.

9. The method of claim 8, wherein the at least one dental procedure is selected from the group comprising repairing a tooth with a filling, repairing a chipped or broken tooth, applying a veneer to a tooth and making a dental impression.

10. The method of claim 8, wherein the drying comprises drying a first tooth with air to create a sufficiently dry tooth surface around the entire first tooth, the first tooth being adjacent to a second tooth on which the at least one dental procedure is performed and applying the strip of PTFE tape around the first tooth to cause the PTFE tape to conform to, self-adhere to and maintain position relative to the first tooth without any adhesive or other element to protect the first tooth from the substances used during the at least one dental procedure.

11. The method of claim 8, wherein the drying comprises drying the gums surrounding an open socket with air to create a gum surface around the open socket, the applying the strip of PTFE tape comprises applying the strip of PTFE tape over the gum surface and open socket to cause the PTFE tape to self-adhere to the gum surface and the at least one dental procedure comprises making a dental impression over the at least one open socket to protect the open socket from the substances used during the dental impression.

12. The method of claim 10, further comprising sufficiently drying a third tooth with air to create a dry tooth surface around the entire third tooth, the third tooth being adjacent to the second tooth and on the opposite side from the first tooth and applying a second strip of PTFE tape by stretching and wrapping the second strip of PTFE tape around the third tooth so as to be within an interdental space between the second tooth and the third tooth to cause the second strip of PTFE tape to conform to, self-adhere to and maintain relative position to the third tooth without any adhesive or other element and to protect the third tooth from the substances used during the at least one dental procedure.

13. The method of claim 10, wherein the applying the strip of PTFE tape around the first tooth comprises wrapping the strip of PTFE tape more than one complete time around the first tooth to cause the strip of PTFE tape to self-adhere to itself where the strip of PTFE tape overlaps.

14. The method of claim 13, wherein the applying the strip of PTFE tape around the first tooth comprises wrapping the strip of PTFE tape around the first tooth and a portion of the adjacent gum.

15. The method of claim 10, wherein the performing at least one dental procedure comprises performing a tooth restoration procedure of the second tooth by applying a composite resin to the second tooth, wherein the strip of PTFE tape protects the first tooth from the exposure to the composite resin used during the tooth restoration procedure.

16. The method of claim 10, wherein the performing at least one dental procedure comprises applying a veneer to the second tooth by applying an adhesive to the second tooth, wherein the strip of PTFE tape protects the first tooth from the exposure to the adhesive used during the application of the veneer.

17. A method of using a dental matrix, comprising;
providing a dental matrix material, the dental matrix material consisting of a strip of PTFE tape of a length sufficient to wrap at least once around a first tooth;
drying the first tooth with air to create a sufficiently dry tooth surface around the entire first tooth;
applying the strip of PTFE tape by stretching and wrapping the strip of PTFE tape around the first tooth and within the interdental space between the first tooth and a second tooth that is an anterior tooth adjacent to the first tooth on which at least one dental procedure is to be performed so as to conform the strip of PTFE tape to the contour of the first tooth and to cause the strip of PTFE tape to conform to the shape of the first tooth and to self-adhere to and maintain position relative to the first tooth;
performing the at least one dental procedure on the second tooth; and
removing the strip of PTFE tape from the first tooth.

18. The method of claim 17, further comprising drying a third tooth with air to create a dry tooth surface around the entire third tooth, the third tooth being adjacent to the second tooth and on the opposite side from the first tooth and applying a second dental matrix material consisting of a second strip of PTFE tape by stretching and wrapping the second strip of PTFE tape around the third tooth so as to be within an interdental space between the second tooth and the third tooth and to cause the second strip of PTFE tape to conform to the shape of the third tooth and to self-adhere to and maintain position relative to the third tooth without any adhesive or any additional element.

19. The method of claim 17, wherein the applying the strip of PTFE tape around the first tooth comprises wrapping the strip of PTFE tape having a thickness of about 3 mils more than one complete time around the first tooth to cause the strip of PTFE tape to overlap upon itself and to self-adhere to itself without any adhesive.

20. The method of claim 17, wherein the applying the strip of PTFE tape around the first tooth comprises wrapping the strip of PTFE tape around the first tooth and a portion of the adjacent gum to cause the PTFE tape to conform and to self-adhere to and maintain position relative to the adjacent gum without any adhesive or other element.
